(19) United States
(12) Patent Application Publication
(10) Pub. No.: US 2012/0181400 A1
(43) Pub. Date: Jul. 19, 2012

(54) Holding Device for a Displaceable Sensor

(76) Inventors: Horst Christof, Aying (DE); Joerg Sander, Ulm (DE); Bartholomaeus Bichler, Raubling (DE); Andreas Loehner, Neu Ulm (DE); Reiner Dittmar, Laupheim (DE); Ulrich Rothmaier, Achstetten (DE)

(21) Appl. No.: 13/390,991

(22) PCT Filed: Aug. 23, 2010
(86) PCT No.: PCT/DE2010/000983

§ 371 Date: Mar. 14, 2012

(30) Foreign Application Priority Data
Aug. 21, 2009 (DE) 10 2009 038 313.1
Oct. 5, 2009 (DE) 10 2009 048 202.4

(51) Int. Cl. G12B 5/00

(52) U.S. Cl. 248/222.52

(57) ABSTRACT

A holding device for a displaceable sensor is provided. The holding device has two or three motor-rotatable rings for accommodating a sensor, and the axes of rotation of the two or three motor-rotatable rings are oblique with respect to one another. The axes of rotation intersect at a virtual pivot point.

### BACKGROUND AND SUMMARY OF THE INVENTION

The present invention relates to a holding device for a displaceable sensor, which can be oriented to a target, on a support structure. Such sensors may be, for example, radar sensors, camera sensors or generally transmitters and/or receivers of electromagnetic radiation.

The term “sensor” for an orientable functional element in the context of the present application is thus not restricted to receiving devices but may likewise include transmitting devices or combined transmitting/receiving devices for electromagnetic radiation.

In order to be able to orient such sensors to a target, a displaceable holding device is required for the sensor. If the support structure itself is likewise displaceable, for example part of an aircraft, a spacecraft, a watercraft or a land vehicle, this holding device must be able to reposition the sensor in such a manner that the latter remains oriented to the target. This also applies when the target is moving.

U.S. Pat. No. 5,860,327 and European Patent Publication No. EP 0 155 922 A1 describe holding arrangements that are suitable for sensors and that can be used to orient the sensors to a possible target. However, as a result of the arrangement of the axes of rotation with respect to one another, repositioning of the sensor with respect to a target results in a wobbling movement of the sensor, which makes it not very suitable for use in aviation.

U.S. Pat. No. 4,575,039 discloses an arrangement in which all axes of rotation coincide at a point outside a sensor. The sensor center of gravity thus moved on a spherical surface, which likewise makes the arrangement not very suitable for use in aviation.

U.S. Pat. No. 4,318,522 discloses a holding arrangement for a satellite. The holding arrangement has three axes of rotation that are each oblique with respect to one another and coincide with the center of gravity of the satellite. The holding device also has motor-rotatable lever arms.

Exemplary embodiments of the present invention are directed to a holding device for a displaceable sensor, which can be used inside an aircraft nose and can be oriented to a target, and which can be fit to a support structure. Because the holding device has a compact construction, it possible to rapidly orient the sensor to the target and also allow the sensor to be rapidly repositioned in the case of a moving target and/or a moving support structure.

The holding device according to one aspect of the invention has three motor-rotatable rings for accommodating a sensor, the axes of rotation of the motor-rotatable rings being oblique with respect to one another. The holding device according to another aspect of the invention has two motor-rotatable rings for accommodating a sensor, the axes of rotation of the two motor-rotatable rings being oblique with respect to one another.

A sensor is understood as meaning an active and/or a passive sensor or an antenna below.

According to the invention, the axes of rotation of the rotatably mounted rings intersect at a virtual pivot point, the virtual pivot point and the geometrical center of gravity of the sensor coinciding. The geometrical center of gravity may also be the center of mass of the sensor. The virtual pivot point may also be in the vicinity of the geometrical center of gravity of the sensor.

According to a first aspect of the invention, a first rotatably mounted ring having a base surface and a covering surface is connected to a support structure of the holding device via a first bearing connected to the base surface. A second rotatably mounted ring having a base surface and a covering surface is connected to the covering surface of the first rotatably mounted ring via a second bearing connected to the base surface and is connected to a third rotatably mounted ring via a third bearing connected to the covering surface, the surface normal of the base surface of the first rotatably mounted ring and the surface normal of the covering surface of the third rotatably mounted ring having an angle α₁ of 0°-90°.

According to a second aspect of the invention, a first rotatably mounted ring having a base surface and a covering surface is connected to a support structure of the holding device via a first bearing connected to the base surface and is connected to a second rotatably mounted ring via a second bearing connected to the covering surface, the surface normal of the base surface of the first rotatably mounted ring and the surface normal of the covering surface of the second rotatably mounted ring having an angle α₁ of 0°-90°.

### BRIEF DESCRIPTION OF THE DRAWING FIGURES

The invention is described and explained in more detail below using drawings, in which:

FIG. 1 shows a holding device with three motor-rotatable rings in 2 positions according to the invention,

FIG. 2 shows a holding device with three motor-rotatable rings in an upward orientation according to the invention,

FIG. 3 shows a holding device with three motor-rotatable rings in a forward orientation according to the invention,

FIG. 4 shows a holding device with two motor-rotatable rings according to the invention,

FIG. 5 shows a schematic illustration of FIG. 1 and FIG. 2 and FIG. 3,

FIG. 6 shows a holding device according to the invention with respect to a sensor target.

### DETAILED DESCRIPTION

For the orientation of a sensor or an antenna, two or three motor-driven rings are required according to the invention in order to always orient the sensor perpendicular to a target point within a particular angle spectrum.

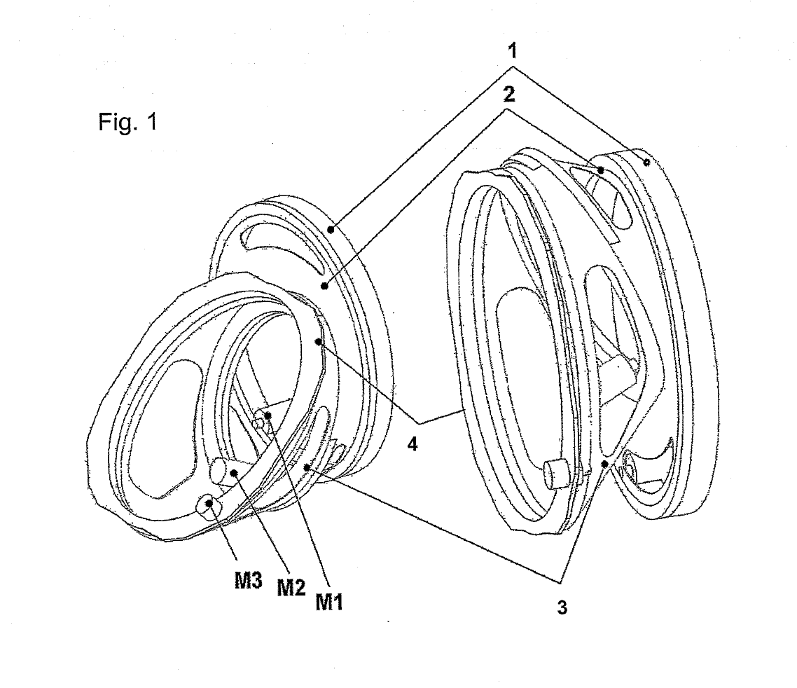

FIG. 1 shows a holding device having a first rotatably mounted ring 2, a second rotatably mounted ring 3 and a third rotatably mounted ring 4. The first rotatably mounted ring 2 is fastened to a support structure 1 of the holding device. The second rotatably mounted ring 3 is arranged between the third rotatably mounted ring 4 and the first rotatably mounted ring 2. The sensor (not illustrated) is fastened to the third rotatably mounted ring 4. Motors M2, M3, M4 are additionally fastened to the rotatably mounted rings 2, 3, 4 in order to drive the rings 2, 3, 4.

The third rotatably mounted ring 4 is connected to the sensor and is used to compensate for rolling. This non-rotation of the antenna with respect to a particular plane could also be effected mechanically, for example, by means of a universal joint (not illustrated) fixed to the support structure 1.

The first rotatably mounted ring 2 is also referred to as the tilting cone, the second rotatably mounted ring 3 is referred to as the rotating cone and the fourth rotatably mounted ring 4 is referred to as the polarization cone.

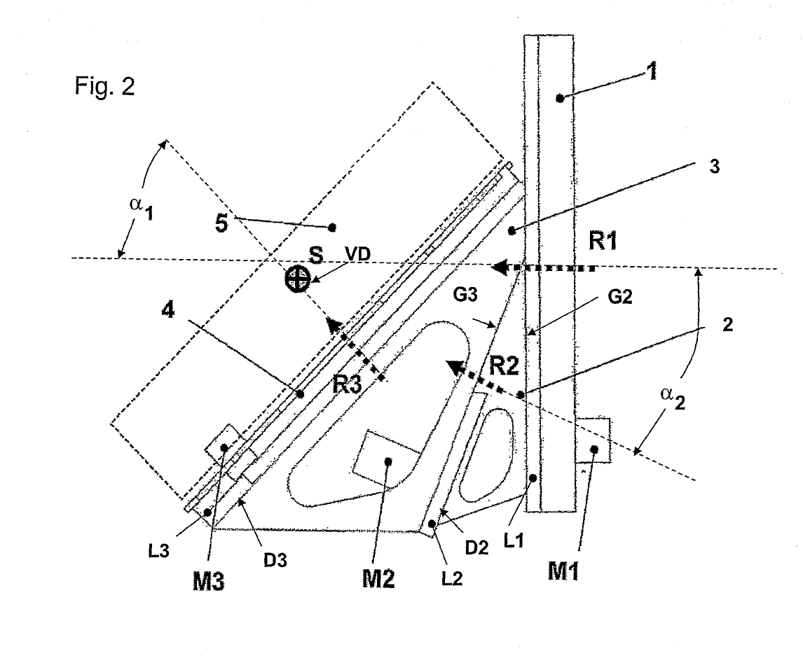

FIG. 2 shows a holding device with three motor-rotatable rings according to the invention in a first, upward orientation. In order to be able to orient the sensor in a defined direction in a certain visual range without exceeding a restricted clearance volume, the axes of rotation R1, R2, R3 of the three rings 2, 3, 4 which are rotatably mounted with respect to one another are arranged obliquely in space in such a manner that these axes of rotation R1, R2, R3 intersect at a virtual pivot point VD. This virtual pivot point VD coincides with the geometrical S of the sensor 5. In one embodiment of the invention, the virtual pivot point VD may also be located in a predefinable radius around the geometrical S of the sensor 5. The required sensor angles can be achieved by means of this arrangement of the axes of rotation R1, R2, R3.

A first rotatably mounted ring 2 has a base surface G2 and a covering surface D2. A first bearing L1 which is connected to the support structure 1 of the holding device is fastened to the base surface G2. A second rotatably mounted ring 3 has a base surface G3 and a covering surface D3. The second ring 3 is connected to the covering surface D2 of the first rotatably mounted ring 2 via a second bearing L2 connected to the base surface G3. The second ring 3 is connected to a third rotatably mounted ring 4 via a third bearing L3 connected to the covering surface D3. The surface normal R1 of the base surface G2 of the first rotatably mounted ring 2 and the surface normal R3 of the covering surface D3 of the second rotatably mounted ring 3 form an angle α₁. The angle α₁ may be an angle range of 0°-90°.

The surface normal R1 of the base surface G2 of the first rotatably mounted ring 2 and the surface normal R2 of the base surface G3 of the second rotatably mounted ring 3 form an angle α₂. This angle is 0°-90°.

The holding device has motors M1, M2, M3. These motors M1, M2, M3 are each connected to the rotatably mounted rings 2, 3, 4 in order to drive the bearings L1, L2, L3. The motor drives M1, M2, M3 drive the respective rotatably mounted rings 2, 3, 4 using a pinion (not illustrated) via a crown gear (not illustrated).

The surface normals R1, R2, R3 form the axes of rotation of the corresponding bearings L1, L2, L3. On account of the fact that the bearings L1, L2, L3 are connected to the rotatable rings 2, 3, 4, the surface normals R1, R2, R3 simultaneously form the axes of rotation of the rings 2, 3, 4.

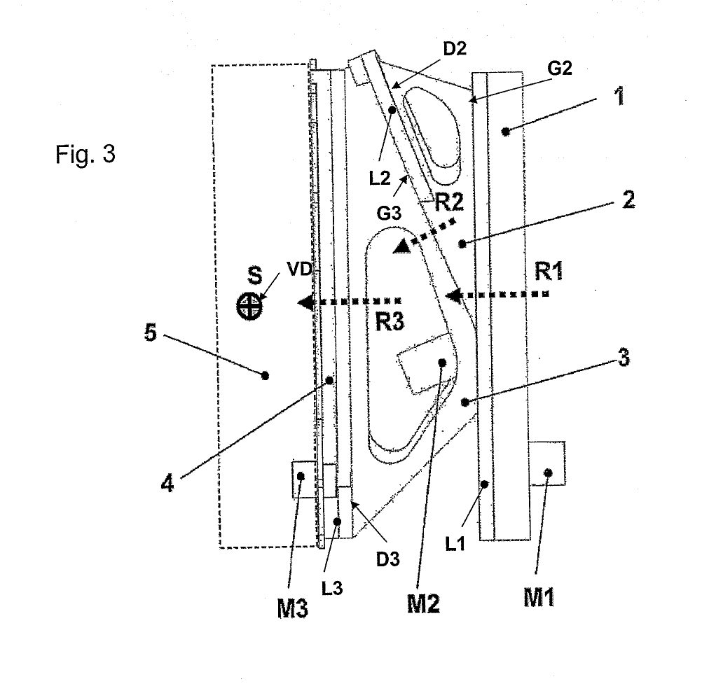

FIG. 3 shows a holding device with three motor-rotatable rings according to the invention in a second, forward orientation. Corresponding reference symbols in FIG. 2 also apply in FIG. 3. In the illustration in FIG. 3, the axes of rotation R1 and R3 are on a common straight line.

If compensation for rolling is required, that is to say an axis of the sensor 5 is always parallel to a plane (for example the horizontal), this is effected using the third rotatably mounted ring 3 to which the sensor 5 is fixed. This ring 3 is also referred to as the polarization ring.

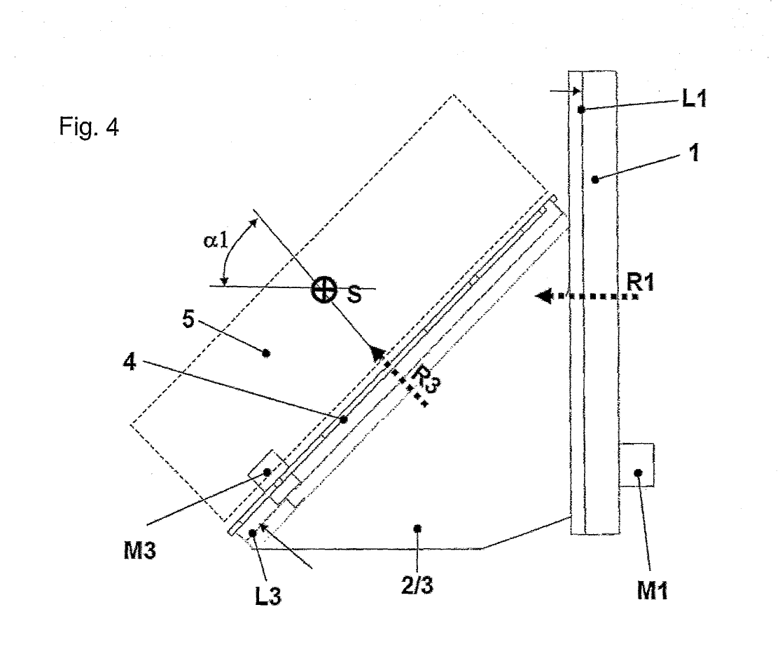

FIG. 4 shows a holding device with two motor-rotatable rings according to the invention. Corresponding reference symbols in FIG. 2 and FIG. 3 also apply in FIG. 4. In FIG. 4, the rotatably mounted rings 2 and 3 have been combined to form a common ring 2/3. The rotatably mounted ring 2/3 is connected according to the explanations for FIG. 2.

The axes of rotation R1 and R3 intersect at the virtual pivot point VD which coincides with the geometrical center of gravity S of the sensor 5.

Such sensor holding devices have a lightweight construction. Such sensor holding devices are flexurally and rotationally rigid.

The funnel-shaped construction of the rings 2, 3, 4 and 2/3, as shown in FIG. 2 to FIG. 4, makes it possible to install all supply lines, such as data cables, power cables and cooling liquid lines (not illustrated), in a protected and undisturbed manner in the interior of the funnels.

In the case of such a sensor holding device, simple rotational movements are involved, the bearings and drives for which can be designed in a simple and reliable manner and can be integrated in a protected manner in the interior of the funnels.

The drives M1, M2, M3 mainly accept only the rotational forces of inertia of the sensor 5.

The main loads produced by external acceleration forces (for example aircraft centrifugal forces) are mainly transmitted by the funnels and their bearings. No additional torques are produced that have to be compensated for by the drives. These kinematics make it possible to optimally reposition the sensor 5 (for example a radar antenna) in an area of very restricted space, according to the invention an aircraft nose. The pivotability around the spatial axes R1 and R2 allows the sensor 5 to be pivoted in any direction inside the pivoting range predefined by the corresponding design (FIG. 2 and FIG. 3).

In a corresponding manner, the sensor 5 can also be continuously repositioned in any of these directions. Depending on the design, continuous rotation may be carried out by using rotating bushings. Only partially continuous rotations can be carried out if no rotating bushings are provided.

A control device for controlling the respective rotary drives is preferably provided in order to harmonize the angles of rotation of the individual rotating funnels or the sensor accommodating ring and thus to control the pivoting movement of the sensor 5.

The control device must harmonize 3 rotational positions in variant 1 (FIG. 2 and FIG. 3) if motorized polarization compensation is intended to be achieved. If this polarization compensation is dispensed with or if it is mechanically achieved, the control device has to harmonize only 2 rotational movements.

The control device in variant 2 (FIG. 4) must harmonize 2 rotational positions if motorized polarization compensation is intended to be achieved.

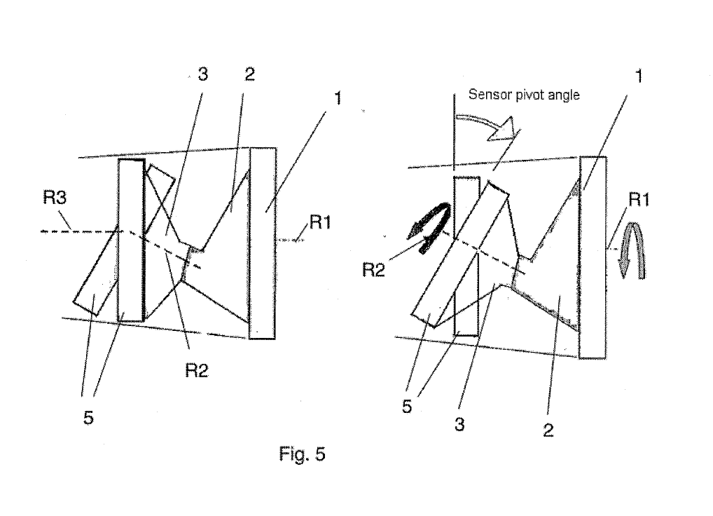

With a lightweight and compact design, such kinematics make it possible to continuously reposition the sensor in all directions with optimum introduction of force and low masses to be rotated. Even in the case of constantly changing coordinates of the target and a moving support structure, for example in the case of a flying aircraft or a moving ship or land vehicle, the kinematics of the holding device according to the invention allow the sensor, for example a radar antenna, to be continuously repositioned within the pivoting range predefined by the design (FIG. 5).

In the case of a sensor in the form of a radar antenna or having a radar antenna, this holding device makes it possible not only to reposition the sensor but also to always keep the polarization plane of the antenna constantly oriented with respect to the target. This naturally also applies to other types of sensors which are preferably intended to be kept in a constant orientation with respect to the target, which also applies, for example, to imaging sensors in the wavelength range of visible light or in another wavelength range.

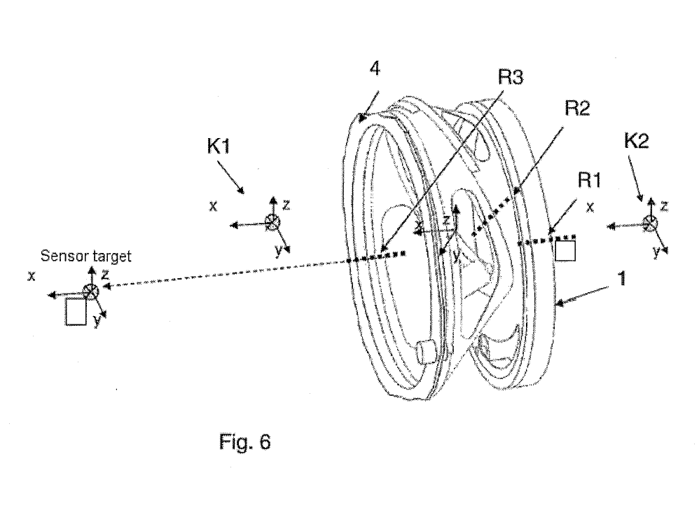

If such a holding device is used in an aircraft for example, both movements of the aircraft around the pitch axis (transverse axis) and around the yaw axis (vertical axis) and movements of the aircraft around its roll axis (longitudinal axis) can be compensated for according to this advantageous development. Movements of the sensor target can also be compensated for in a corresponding manner (FIG. 6). The sensor can be simultaneously rotated around all axes of the central rotation point. Most of the sensor mass forces are diverted to the aircraft structure via the rotating rings.

The holding device makes it possible to continuously track a moving sensor target while simultaneously compensating for a basic structure which rotates in space and is mounted on an aircraft, for example.

The y axis of the polarization ring 4 (or sensor 5) remains parallel with respect to the xy plane of the first ring 2 or aircraft (FIG. 6). In FIG. 6, K1 is used to denote the coordinate system of the polarization ring 4 or sensor 5. K2 is used to denote the coordinate system of the support structure 1 or an aircraft comprising the support structure 1.

The sensor advantageously has a transmitting and/or receiving antenna. In one particularly preferred embodiment of the invention, the sensor is in the form of a radar sensor and has a radar antenna, for example. However, the invention is not restricted to a radar sensor, but rather the holding device according to the invention is also suitable for other sensors, for example imaging sensors, or other types of antennas or else for an echo sounder, for example. In this case, the invention is not restricted to the sensor having or being a receiver or an antenna, but rather the sensor is an orientable functional element which, according to the definition of the term “sensor” in this application, can be formed by or can have a transmitting device or an antenna or can be a combination of a transmitting and a receiving device or relevant antennas. In this sense, a transmitting device should also be understood as meaning, for example, an energy emitter (for example a laser emitter) of a beam weapon.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SYMBOLS

1 Support structure
2 Tilting cone
3 Rotating cone
4 Polarization ring
Sensor fixed to polarization ring 4
R1 Axis of rotation of support structure 1 and tilting cone 2
R2 Axis of rotation of tilting cone 2 and rotating cone 3
R3 Axis of rotation of polarization ring 4 and rotating cone 3
M1 Motor1 rotates the tilting cone 2 with respect to the support structure
M2 Motor2 rotates the rotating cone 3 with respect to the tilting cone 2
M3 Motor3 rotates the polarization ring 4 with respect to the rotating cone 3
S Center of gravity of the sensor 5
2/3 Integral tilting/rotating cone
VD Virtual pivot point
K1 Coordinate system of the polarization ring 4
K2 Coordinate system of the support structure 1

1-12. (canceled)

13. A holding device for a displaceable sensor, which can be repositioned inside an aircraft nose, the holding comprising:
three motor-rotatable rings configured to accommodate the sensor, wherein axes of rotation of the three motor-rotatable rings are oblique with respect to one another, the axes of rotation of the three motor-rotatable rings intersecting at a virtual pivot point, and the virtual pivot point and a geometrical center of gravity of the sensor coinciding,
wherein a first motor-rotatable ring of the three motor-rotatable rings has a base surface and a covering surface is connected to a support structure of the holding device via a first bearing connected to the base surface,
wherein a second motor-rotatable ring of the three motor-rotatable rings has a base surface and a covering surface is connected to the covering surface of the first motor-rotatable ring via a second bearing connected to the base surface and is connected to a third motor-rotatable ring of the three motor-rotatable rings via a third bearing connected to the covering surface of the second motor-rotatable ring,
wherein a surface normal of the base surface of the first motor-rotatable ring and a surface normal of the covering of the second motor-rotatable ring have an angle α₁ of 0°-90°.

14. The holding device as claimed in claim 13, wherein the surface normal of the base surface of the first motor-rotatable ring and the surface normal of the base surface of the second motor-rotatable ring have an angle of α₂ of 0°-90°.

15. The holding device as claimed in claim 14, wherein motor devices are configured to respectively drive the three motor-rotatable rings using a pinion via a crown gear.

16. The holding device as claimed in claim 14, wherein motor drives are configured to respectively drive the first and second motor-rotatable rings using a pinion via a crown gear, and a mechanical universal joint is configured to establish a movable mechanical universal connection between the support structure and the third motor-rotatable ring.

17. The holding device as claimed in claim 14, wherein a polarization plane of the sensor is kept constant on a target using the three motor-rotatable rings.

18. A holding device for a displaceable sensor for arrangement in an aircraft nose, the holding device comprising:
two motor-rotatable rings configured to accommodate a sensor, wherein axes of rotation of the two motor-rotatable rings are oblique with respect to one another, the axes of rotation of the two motor-rotatable rings intersecting at a virtual pivot point, and the virtual pivot point and a geometrical center of gravity of the sensor coinciding,
wherein a first motor-rotatable ring of the two motor-rotatable rings has a base surface and a covering surface is connected to a support structure of the holding device via a first bearing connected to the base surface and is connected to a second motor-rotatable ring of the two motor-rotatable rings via third bearing connected to the covering surface,
wherein a surface normal of the base surface of the first motor-rotatable ring and a surface normal of the covering surface of the second motor-rotatable ring has an angle α₁ of 0°-90°.

19. The holding device as claimed in claim 18, wherein motor drives are configured to respectively drive the two motor-rotatable rings using a pinion via a crown gear.

20. The holding device as claimed in claim 18, wherein a motor drive is configured to drive the first motor-rotatable ring using a pinion via a crown gear, and a mechanical universal joint is configured to establish a movable mechanical universal connection between the support structure and the second motor-rotatable ring.

21. The holding device as claimed in claim 18, wherein a polarization plane of the sensor is kept constant on a target using the two motor-rotatable rings.
